(19) United States
(12) Patent Application Publication
(10) Pub. No.: US 2025/0079086 A1
(43) Pub. Date: Mar. 6, 2025

(54) MULTILAYER CERAMIC CAPACITOR

(71) Applicant: SAMSUNG ELECTRO-MECHANICS CO., LTD., Suwon-si (KR)

(72) Inventors: Heesang Kang, Suwon-si (KR); Sujin Lee, Suwon-si (KR)

(73) Assignee: SAMSUNG ELECTRO-MECHANICS CO., LTD., Suwon-si (KR)

(21) Appl. No.: 18/585,613

(22) Filed: Feb. 23, 2024

(30) Foreign Application Priority Data
Sep. 1, 2023 (KR) 10-2023-0116379

(51) Int. Cl. H01G 4/232; H01G 4/012; H01G 4/30

(52) U.S. Cl. CPC H01G 4/232; H01G 4/012; H01G 4/105; H01G 4/30

(57) ABSTRACT

The disclosed multilayer ceramic capacitor includes a ceramic main body including a first surface and a second surface facing in a first direction, a third surface and a fourth surface facing in a second direction and connecting the first surface and the second surface, and a fifth surface and a sixth surface facing in a third direction and connecting the first surface and the second surface, an internal electrode disposed inside the ceramic main body, a protective layer disposed on the third surface and the fourth surface of the ceramic main body, and a connection electrode covering the protective layer. The protective layer includes a first protective layer disposed on the third surface and a second protective layer disposed on the fourth surface, and has openings positioned on the third surface and the fourth surface.

### CROSS-REFERENCE TO RELATED APPLICATION

This application claims priority to and the benefit of Korean Patent Application No. 10-2023-0116379 filed in the Korean Intellectual Property Office on Sep. 1, 2023, the entire contents of which are incorporated herein by reference.

### BACKGROUND

### (a) Technical Field

This present disclosure relates to a multilayer ceramic capacitor.

### (b) Description of the Related Art

As electronic products have tended to be reduced in size, multilayer ceramic capacitors have accordingly been required to be reduced in size and yet have a large capacity. In accordance with the demand for miniaturization and high capacitance in multilayer ceramic capacitors, external electrodes of thereof are also required to be thinner.

The paste that forms the external electrode uses a conductive metal such as copper (Cu) as a main material thereof, thereby securing sealing property and electrical connectivity with a ceramic main body. In addition, glass is used as an auxiliary material to fill empty spaces during sintering shrinkage of conductive metals, while providing bonding force between the external electrode and the ceramic main body.

Multilayer ceramic capacitors are classified based on their length and width. Therefore, even in multilayer ceramic capacitors having the same length or width, the size of the ceramic main body may vary depending on the thickness of the external electrode, and the capacitance may vary accordingly. Therefore, in order to increase capacitance while maintaining the length and width, the external electrode must be manufactured thinly. However, if the external electrode becomes thin, the risk of moisture penetrating into the interior of the ceramic main body may increase.

### SUMMARY

The present disclosure attempts to provide a ceramic capacitor capable of improving moisture resistant reliability by suppressing moisture penetration into a ceramic main body.

However, embodiments of the present disclosure are not limited to those mentioned above, and may be variously extended in the scope of the technical ideas included in the present disclosure.

A multilayer ceramic capacitor according to embodiments includes a ceramic main body including a first surface and a second surface facing each other in a first direction, a third surface and a fourth surface facing each other in a second direction and connecting the first surface and the second surface, and a fifth surface and a sixth surface facing each other in a third direction and connecting the first surface and the second surface, an internal electrode disposed inside the ceramic main body, a protective layer disposed on the third surface and the fourth surface of the ceramic main body, and a connection electrode covering the protective layer. The protective layer includes a first protective layer disposed on the third surface and a second protective layer disposed on the fourth surface, and has one or more openings positioned on the third surface and the fourth surface.

The first protective layer and the second protective layer may include portions extending to the first surface and the second surface, respectively.

The internal electrode may be connected to the connection electrode through the one or more openings.

The protective layer may include silicon (Si) oxide.

The protective layer may have an electrical conductivity of less than 10⁻⁷ S/cm.

The protective layer may further include sodium oxide (Na₂O).

The protective layer may further include copper (II) oxide (CuO).

The connection electrode may include particles of the same material as the protective layer.

The connection electrode may include a first connection electrode that at least partially covers the first protective layer and a second connection electrode that at least partially covers the second protective layer, the first protective layer may have a portion that protrudes further than the first connection electrode in a direction toward the fourth surface on the first and second surfaces of the ceramic main body, and the second protective layer may have a portion that protrudes further than the second connection electrode in a direction toward the third surface on the first and second surfaces of the ceramic main body.

The multilayer ceramic capacitor may further include a first plating electrode that at least partially covers the first connection electrode and a second plating electrode that at least partially covers the second connection electrode. The first protective layer may have a portion that protrudes further than the first plating electrode in the direction toward the fourth surface on the first and second surfaces of the ceramic main body, and the second protective layer may have a portion that protrudes further than the second plating electrode in the direction toward the third surface on the first and second surfaces of the ceramic main body.

The first protective layer and the second protective layer may have a portion in contact with the ceramic main body.

The portions of the first protective layer and the second protective layer may extend continuously without an opening on the first surface and the second surface.

The protective layer may include glass including sodium (Na), copper (II) (Cu), and silicon (Si).

A multilayer ceramic capacitor according to another embodiment includes a ceramic main body including a first surface and a second surface facing each other in a first direction, a third surface and a fourth surface facing each other in a second direction and connecting the first surface and the second surface, and a fifth surface and a sixth surface facing each other in a third direction and connecting the first surface and the second surface, an internal electrode disposed inside the ceramic main body, a protective layer disposed on a portion of the third surface and a portion of the fourth surface of the ceramic main body, and a connection electrode covering the protective layer. The connection electrode includes a portion in contact with the internal electrode through a portion where the protective layer is not positioned on the third and fourth surfaces of the ceramic main body.

The protective layer may include a portion extending to the first surface and the second surface.

An opening is disposed in the portion where the protective layer is positioned on the third and fourth surfaces of the ceramic main body, and the protective layer may have a portion continuously extending from an end of the protective layer on the first or second surface to another end of the protective layer positioned on one side of the opening.

The protective layer may include a first protective layer extending along the first surface, the third surface and the second surface, and a second protective layer extending along the first surface, the fourth surface, and the second surface. The connection electrode may include a first connection electrode covering the first protective layer and a second connection electrode covering the second protective layer, the first protective layer may have a portion that protrudes further than the first connection electrode in a direction toward the fourth surface on the first and second surfaces, the second protective layer may have a portion that protrudes further than the second connection electrode in a direction toward the third surface on the first and second surfaces.

A first plating electrode covering the first connection electrode and a second plating electrode covering the second connection electrode may be further included. The first protective layer may have a portion that protrudes further than the first plating electrode in a direction toward the fourth surface on the first and second surfaces, and the second protective layer may have a portion that protrudes further than the second plating electrode in a direction toward the third surface on the first and second surfaces.

The portion of the protective layer may extend continuously without an opening on the first surface and the second surface.

The protective layer may include glass including sodium (Na), copper (II) (Cu), and silicon (Si).

According to the multilayer ceramic capacitor according to the embodiment, it is possible to prevent moisture from penetrating into the ceramic main body even when the external electrode is formed thinly.

In addition, it is possible to improve defects such as the external electrode falling off during sintering of the external electrode and the plating spreading to unwanted areas of the ceramic main body when forming the plating electrode.

### BRIEF DESCRIPTION OF THE DRAWINGS

FIG. 1 is a perspective view of a multilayer ceramic capacitor according to embodiments.

FIG. 2 is a cross-sectional view taken along II-II′ line in FIG. 1.

FIG. 3 is a cross-sectional view taken along III-III′ line in FIG. 1.

FIG. 4 is an enlarged partial cross-sectional view of part A of FIG. 2.

FIG. 5 is an enlarged partial cross-sectional view of part B of FIG. 2.

FIG. 6 is a diagram illustrating a manufacturing method of a multilayer ceramic capacitor according to embodiments.

### DETAILED DESCRIPTION

Hereinafter, the present disclosure will be described in detail hereinafter with reference to the accompanying drawings, in which embodiments of the present disclosure are shown. The drawings and description are to be regarded as illustrative in nature and not restrictive. Like reference numerals designate like elements throughout the specification. In the accompanying drawings, some constituent elements are exaggerated, omitted, or schematically illustrated, and the size of each constituent element does not entirely reflect the actual size.

The accompanying drawings are intended only to facilitate an understanding of the exemplary embodiments disclosed in this specification, and it is to be understood that the technical ideas disclosed herein are not limited by the accompanying drawings and include all modifications, equivalents, or substitutions that are within the range of the ideas and technology of the present disclosure.

Although terms of “first,” “second,” and the like are used to explain various constituent elements, the constituent elements are not limited to such terms. These terms are only used to distinguish one constituent element from another constituent element.

In addition, it will be understood that when an element such as a layer, film, region, or substrate is referred to as being “on” another element, it can be directly on the other element or intervening elements may also be present. In contrast, when an element is referred to as being “directly on” another element, there are no intervening elements present. Further, when an element is referred to as being “on” or “above” a reference element, it can be positioned above or below the reference element, and it is not necessarily referred to as being positioned “on” or “above” in a direction opposite to gravity.

Throughout the specification, the terms “comprise” or “have” are intended to specify the presence of stated features, integers, steps, operations, constituent elements, components or a combination thereof, but do not preclude the presence or addition of one or more other features, integers, steps, operations, constituent elements, components, and/or groups thereof. Therefore, unless explicitly described to the contrary, the word “comprise” and variations such as “comprises” or “comprising” will be understood to imply the inclusion of stated constituent elements but not the exclusion of any other constituent elements.

Further, throughout the specification, the phrase “in a plan view” or “on a plane” means viewing a target portion from the top, and the phrase “in a cross-sectional view” or “on a cross-section” means viewing a cross-section formed by vertically cutting a target portion from the side.

Throughout the specification, the term “connected” does not mean only that two or more constituent components are directly connected, but may also mean that two or more constituent components are indirectly connected through another constituent component, that two or more components are electrically connected as well as physically connected, or that two or more constituent components are referred to by different names but are united by location or function.

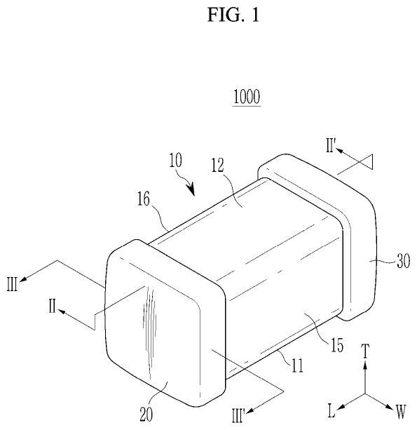

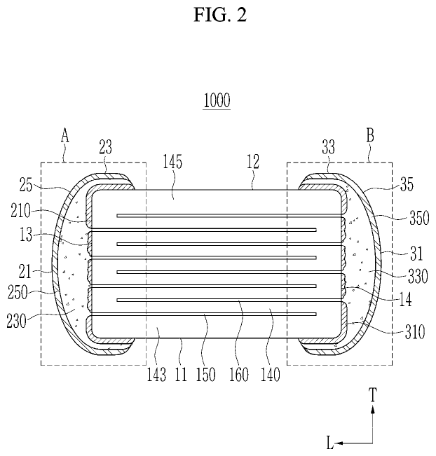

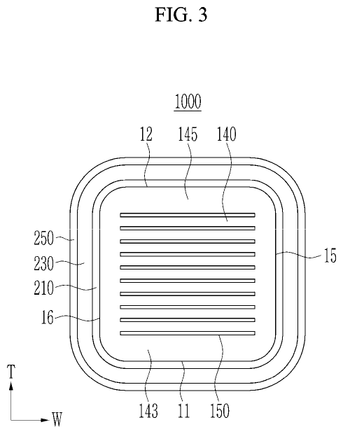

FIG. 1 is a perspective view schematically showing a multilayer ceramic capacitor according to embodiments. FIG. 2 is a cross-sectional view taken along II-II′ line of FIG. 1. FIG. 3 is a cross-sectional view taken along III-III′ line of FIG. 1.

Referring to FIGS. 1 to 3, a multilayer ceramic capacitor 1000 according to the embodiment includes a ceramic main body 10, a plurality of internal electrodes 150 and 160, protective layers 210 and 310, a first external electrode 20, and a second external electrode 30.

First, defining direction to clearly describe the present embodiment, the L-axis, W-axis, and T-axis shown in the drawings refer to axes representing the length direction (e.g., second direction), width direction (e.g., third direction), and thickness direction (e.g., first direction) of the multilayer ceramic capacitor 1000, respectively.

The thickness direction (T-axis direction) may be a direction perpendicular to the broad surface (main surface) of sheet-shaped components. For example, the thickness direction (T-axis direction) may be used in the same direction as the direction in which a dielectric layer 140 is stacked.

The length direction (L-axis direction) is a direction parallel to the wide surface (main surface) of the sheet-shaped components, and may be a direction that intersects or is perpendicular to the thickness direction (T-axis direction). For example, the length direction (L-axis direction) may be a direction in which the first external electrode 20 and the second external electrode 30 face each other.

The width direction (W-axis direction) is a direction parallel to the wide surface (main surface) of the sheet-shaped components, and may be a direction that intersects or is perpendicular to the thickness direction (T-axis direction) and the length direction (L-axis direction).

The ceramic main body 10 may have a substantially hexahedral shape, but the present embodiment is not limited thereto. Due to shrinkage during sintering, the ceramic main body 10 may not have a completely hexahedral shape, but may have a substantially hexahedral shape. For example, the ceramic main body 10 may have a substantially rectangular parallelepiped shape, but portions corresponding to corners or vertices may have a rounded shape.

For better understanding and ease of description, in this embodiment, the surfaces facing each other in the thickness direction (T-axis direction, e.g., first direction) are defined as a first surface 11 and a second surface 12, and the surfaces facing each other in the length direction (L-axis direction, e.g., second direction) and connecting the first surface 11 and the second surface 12 are defined as a third surface 13 and a fourth surface 14. The surfaces facing each other in the width direction (W-axis direction, e.g., third direction) and intersecting the third and fourth surfaces 13 and 14 are defined as a fifth surface 15 and a sixth surfaces 16.

Accordingly, a first direction in which the first surface 11 and the second surface 12 face each other may be the thickness direction (T-axis direction), and second and third directions perpendicular to the first direction and perpendicular to each other may be the length direction (L-axis direction) and the width direction (W-axis direction), or the width direction (W-axis direction) and the length direction (L-axis direction), respectively.

The length of the ceramic main body 10 may mean, based on an optical microscope or scanning electron microscope (SEM) photograph of the length direction (L-axis direction)-thickness direction (T-axis direction) cross-section at a width direction (W-axis direction) central portion of the ceramic main body 10, the maximum value among the lengths of a plurality of line segments each connecting two outermost boundary lines opposite in the length direction (L-axis direction) of the ceramic main body 10, which is shown in the above-described cross-sectional photograph, and parallel to the length direction (L-axis direction). Meanwhile, the length of the ceramic main body 10 may mean the minimum value among the lengths of a plurality of line segments each connecting two outermost boundary lines opposite in the length direction (L-axis direction) of the ceramic main body 10, which is shown in the above-described cross-sectional photograph, and parallel to the length direction (L-axis direction). Meanwhile, the length of the ceramic main body 10 may mean an arithmetic average value of the lengths of at least two line segments among a plurality of line segments each connecting two outermost boundary lines opposite in the length direction (L-axis direction) of the ceramic main body 10, which is shown in the above-described cross-sectional photograph, and parallel to the length direction (L-axis direction).

The thickness of the ceramic main body 10 may mean, based on an optical microscope or SEM photograph of the length direction (L-axis direction)-thickness direction (T-axis direction) cross-section at a width direction (W-axis direction) central portion of the ceramic main body 10, the maximum value among the lengths of a plurality of line segments each connecting t boundary lines opposite in the thickness direction (T-axis direction) of the ceramic main body 10, which is shown in the above-described cross-sectional photograph, and parallel to the thickness direction (T-axis direction). Meanwhile, the thickness of the ceramic main body 10 may mean the minimum value among the lengths of a plurality of line segments each connecting two outermost boundary lines opposite in the thickness direction (T-axis direction) of the ceramic main body 10, which is shown in the above-described cross-sectional photograph, and parallel to the thickness direction (T-axis direction). Meanwhile, the thickness of the ceramic main body 10 may mean an arithmetic average value of the lengths of at least two line segments among a plurality of line segments, each connecting two outermost boundary lines opposite in the thickness direction (T-axis direction) of the ceramic main body 10, which is shown in the above-described cross-sectional photograph, and parallel to the thickness direction (T-axis direction).

The thickness of the ceramic main body 10 may mean, based on an optical microscope or SEM photograph of the length direction (L-axis direction)-width direction (W-axis direction) cross-section at a thickness direction (T-axis direction) central portion of the ceramic main body 10, the maximum value among the lengths of a plurality of line segments each connecting two outermost boundary lines opposite in the width direction (W-axis direction) of the ceramic main body 10, which is shown in the above-described cross-sectional photograph, and parallel to the width direction (W-axis direction). Meanwhile, the width of the ceramic main body 10 may mean the minimum value among the lengths of a plurality of line segments each connecting two outermost boundary lines opposite in the width direction (W-axis direction) of the ceramic main body 10, which is shown in the above-described cross-sectional photograph, and parallel to the width direction (W-axis direction). Meanwhile, the width of the ceramic main body 10 may mean an arithmetic average value of the lengths of at least two line segments among a plurality of line segments, each connecting two outermost boundary lines opposite in the width direction (W-axis direction) of the ceramic main body 10, which is shown in the above-described cross-sectional photograph, and parallel to the width direction (W-axis direction).

The ceramic main body 10 may be formed by stacking a plurality of dielectric layers 140 in the thickness direction (T-axis direction) and then sintering them. Here, each of the plurality of adjacent dielectric layers 140 of the ceramic main body 10 may be integrated with each other with unclear boundaries. In other words, the boundaries between each adjacent dielectric layer 140 of the ceramic main body 10 may be integrated to the extent that it is difficult to check without using the SEM.

The internal electrodes 150 and 160 include a first internal electrode 150 and a second internal electrode 160 having different polarities. The plurality of first and second internal electrodes 150 and 160 may be alternately arranged in the thickness s direction (T-axis direction) within the ceramic main body 10 with the dielectric layer 140 interposed therebetween. The first internal electrode 150 and the second internal electrode 160 adjacent to each other may be electrically insulated from each other by the dielectric layer 140 disposed therebetween.

The plurality of first and second internal electrodes 150 and 160 may be disposed alternately with the dielectric layer 140 interposed therebetween so as to partially overlap each other in the thickness direction (T-axis direction). Ends of the plurality of first internal electrodes 150 may be exposed through the third surface 13 of the ceramic main body 10, and ends of the plurality of second internal electrodes 160 may be exposed through the fourth surface 14 of the ceramic main body 10. Ends of the plurality of first and second internal electrodes 150 and 160 alternately exposed through the third and fourth surfaces 13 and 14 of the ceramic main body 10 may be electrically connected with first and second connection portions 21 and 31 of the first and second external electrodes 20 and 30 on the third and fourth surfaces 13 and 14 of the ceramic main body 10, respectively.

The first and second internal electrodes 150 and 160 may be formed by printing a conductive paste including a conductive metal on the surface of the dielectric layer 140. For example, an internal electrode may be formed by printing a conductive paste including nickel (Ni) or a nickel (Ni) alloy on the surface of the dielectric layer using screen printing or gravure printing. However, this embodiment is not limited thereto.

For example, the first and second internal electrodes 150 and 160 may have an average thickness of approximately 0.1 μm or more and 2 μm or less.

According to the above configuration, when voltage is applied to the first and second external electrodes 20 and 30, charges are accumulated between the first and second internal electrodes 150 and 160 that face each other. The capacitance of the multilayer ceramic capacitor 1000 is proportional to the overlapping area of the first and second internal electrodes 150 and 160 that overlap each other along the thickness direction (T-axis direction).

The multilayer ceramic capacitor 1000 includes an active region and a margin region. The active region is the region where the plurality of first and second internal electrodes 150 and 160 overlap along the thickness direction (T-axis direction), and the margin region is the region between the active region and the third and fourth surfaces 13 and 14 of the ceramic main body 10.

First and second cover layers 143 and 145 may be disposed on both sides outside the plurality of first and second internal electrodes 150 and 160, respectively, along the thickness direction (T-axis direction) within the ceramic main body 10.

That is, within the ceramic main body 10, the first cover layer 143 may be provided below the internal electrode at the lowermost part, and the second cover layer 145 may be provided above the internal electrode at the uppermost part. The first and second cover layers 143, 145 may have the same composition as the dielectric layer 140, and may be formed by stacking one or more dielectric layers not including the internal electrodes, below the internal electrode at the lowermost part and above the internal electrode at the uppermost part of the ceramic main body 10, respectively.

The first and second cover layers 143 and 145 may serve to prevent damage to the first and second internal electrodes 150 and 160 that may occur due to physical or chemical stress. The dielectric layer 140 may include a high dielectric constant ceramic material. For example, the ceramic material may include a dielectric ceramic including components such as BaTiO₃, CaTiO₃, SrTiO₃, or CaZrO₃. In addition, these components may further include auxiliary components such as Mn compounds, Fe compounds, Cr compounds, Co compounds, and Ni compounds. For example, the dielectric layer may include (Ba₁₋ₓCaₓ)TiO₃, Ba(Ti_{1-y}Ca_{y})O₃, (Ba₁₋ₓCaₓ)(Ti_{1-y}Zr_{y})O₃, or Ba(Ti_{1-y}Zr_{y})O₃, in which Ca (calcium), Zr (zirconium), etc. are partially used in BaTiO₃. However, the present disclosure is not limited thereto.

Additionally, the dielectric layer 140 may further include one or more of a ceramic additive, an organic solvent, a plasticizer, a binder, and a dispersant. Ceramic additives may include, for example, transition metal oxides or carbides, rare earth elements, magnesium (Mg), or aluminum (Al).

For example, the average thickness of the dielectric layer 140 may be 0.1 μm to 10 μm, but the present embodiment is not limited thereto.

The external electrodes 20 and 30 are provided on the outside of the ceramic main body 10, and include the first external electrode 20 and the second external electrode 30. The first and second external electrodes 20 and 30 are disposed on the third and fourth surfaces 13 and 14 in the length direction (L-axis direction) of the ceramic main body 10, and may extend to the first surface 11, the second surface 12, the fifth surface 15, and the sixth surface 16. In another embodiment, the first and second external electrodes 20 and 30 may extend to a portion of either the first surface 11 or the second surface 12.

The first and second external electrodes 20 and 30 each include the first and second connection portions 21 and 31, first and second band portions 23 and 33, and first and second corner portions 25 and 35.

The first connection portion 21 covers the third surface 13 of the ceramic main body 10, and is electrically connected to the exposed ends of the plurality of first or second internal electrodes 150 and 160. The second connection portion 31 covers the fourth surface 14 of the ceramic main body 10, and is electrically connected to the exposed ends of the plurality of first or second internal electrodes 150 and 160. In another embodiment, the first and second connection portions 21 and 31 may cover parts of the third surface 13 and the fourth surface 14.

The first and second band portions 23 and 33 extend from the first and second connection portions 21 and 31 and covers at least part of the first surface 11, the second surface 12, the fifth surface 15, and the sixth surface 16 of the ceramic main body 10. The first and second band portions 23 and 33 may allow the first and second external electrodes 20 and 30 to be more strongly adhered to the ceramic main body 10.

The first band portion 23 may extend from the first connection portion 21 and cover at least part of the first surface 11, the second surface 12, the fifth surface 15, and the sixth surface 16 of the ceramic main body 10. The second band portion 33 may extend from the second connection portion 31 and cover at least part of the first surface 11, the second surface 12, the fifth surface 15, and the sixth surface 16 of the ceramic main body 10.

The first and second corner portions 25 and 35 may be portions that connect the first and second connection portions 21 and 31 and the first and second band portions 23 and 33.

Based on an optical microscope or SEM photograph of the length direction (L-axis direction)-thickness direction (T-axis direction) cross-section at a width direction (W-axis direction) central portion of the multilayer ceramic capacitor 1000, in the multilayer ceramic capacitor 1000 shown in the above-described cross-sectional photograph, the first and second connection portions 21 and 31 may have a shape generally parallel to the thickness direction (T-axis direction), the first and second band portions 23 and 33 may have a shape that is generally parallel to the length direction (L-axis direction), and the first and second corner portions 25 and 35 may have a curved shape. The above-described curved shape may be a curved shape with a tangent whose slope changes from a direction parallel to the thickness direction (T-axis direction) to a direction parallel to the length direction (L-axis direction) (or to the opposite direction).

The external electrodes 20 and 30 may include connection electrodes 230 and 330 and plating electrodes 250 and 350. The connection electrodes 230, 330 and the plating electrodes 250, 350 may be positioned on at least a part of the first and second connection portions 21 and 31, the first and second band portions 23 and 33, and the first and second corner portions 25 and 35, respectively.

The first external electrode 20 may include the first connection electrode 230 and the first plating electrode 250, and the second external electrode 30 may include the second connection electrode 330 and the second plating electrode 350.

The connection electrodes 230 and 330 may include copper (Cu). In addition, the connection electrodes 230 and 330 include copper (Cu) as a main component, and may include one or more materials among nickel (Ni), tin (Sn), palladium (Pd), platinum (Pt), gold (Au), silver (Ag), tungsten (W), titanium (Ti), lead (Pb), or alloys thereof.

The connection electrodes 230 and 330 may include protective particles 235 and 335. The protective particles 235, 335 may include a glass component having a mixed composition of oxides, and may include one or more components selected from the group consisting of boron oxide, aluminum oxide, transition metal oxide, alkali metal oxide, and alkaline earth metal oxide in combination with silicon oxide. For example, the protective particles 235, 335 may include, but are not limited to, one or more components of barium oxide (BaO), calcium oxide (CaO), zinc oxide (ZnO), aluminum oxide (Al₂O₃), boron oxide (B₂O₃), sodium oxide (Na₂O), and copper (II) oxide (CuO) in combination with silicon dioxide (SiO₂).

Additionally, the protective particles 235 and 335 may include more than 10 mol % of sodium oxide (Na₂O) and more than 4 mol % of copper (II) oxide (CuO), but are not limited thereto.

The protective particles 235 and 335 may be particles of glass material, and may be particles of the same material as the protective layers 210 and 310, which will be described later.

For example, a method of forming the connection electrode 230, 330 may include dipping the ceramic main body 10 into a conductive paste including conductive metal and glass, printing the conductive paste on the surface of the ceramic main body 10 using screen printing or gravure printing methods, or applying the conductive paste on the surface of the ceramic main body 10.

The connection electrodes 230 and 330 may include the first connection electrode 230 disposed on the third surface 13 and the second connection electrode 330 disposed on the fourth surface 14 of the ceramic main body 10. The first connection electrode 230 may be disposed on the first connection portion 21 and may extend to the first corner portion 25 and the first band portion 23. The second connection electrode 330 may be disposed on the second connection portion 31 and may extend to the second corner portion 35 and the second band portion 33.

The plating electrodes 250 and 350 may include nickel (Ni) as a main component, and may include nickel (Ni), copper (Cu), tin (Sn), palladium (Pd), platinum (Pt), gold (Au), silver (Ag), tungsten (W), titanium (Ti), or lead (Pb) alone or alloys thereof, but the present embodiment is not limited thereto. For example, the plating electrodes 250 and 350 may be formed by sputtering or electrolytic plating (Electric Deposition).

The plating electrodes 250 and 350 may include the first plating electrode 250 that at least partially covers the first connection electrode 230 and the second plating electrode 350 that at least partially covers the second connection electrode 330. The first plating electrode 250 may be disposed on the first connection portion 21 and may extend to the first corner portion 25 and the first band portion 23. The second plating electrode 350 may be disposed on the second connection portion 31 and may extend to the second corner portion 35 and the second band portion 33.

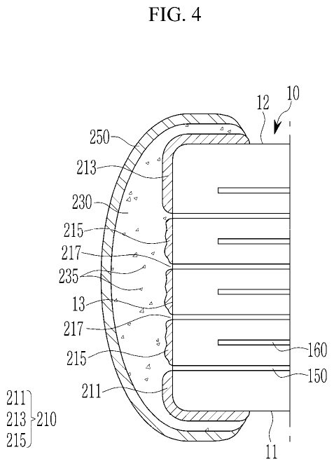

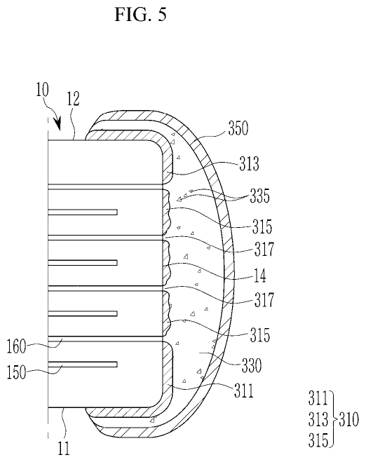

FIG. 4 is an enlarged partial cross-sectional view of part A of FIG. 2, and FIG. 5 is an enlarged partial cross-sectional view of part B of FIG. 2.

Referring to FIGS. 4 and 5, the protective layers 210 and 310 may be disposed on the third and fourth surfaces 13 and 14 of the ceramic main body 10. The protective layers 210 and 310 may be at least partially covered by the connection electrodes 230 and 330. The protective layers 210 and 310 may include the first protective layer 210 disposed on the third surface 13 and the second protective layer 310 disposed on the fourth surface 14 of the ceramic main body 10.

The first protective layer 210 may include a portion extending from the third surface 13 onto the first surface 11 and the second surface 12 of the ceramic main body 10. Additionally, the first protective layer 210 may include a portion extending from the third surface 13 onto the fifth surface 15 and the sixth surface 16 of the ceramic main body 10. The first protective layer 210 may be at least partially covered by the first connection electrode 230. The first protective layer 210 may have a portion positioned between the ceramic main body 10 and the first connection electrode 230, and may be in contact with the ceramic main body 10. The first protective layer 210 may serve to bond the ceramic main body 10 and the first connection electrode 230.

The first protective layer 210 may have a first opening 217 formed on the third surface 13 of the ceramic main body 10. The first opening 217 is a portion where the first protective layer 210 is not partially disposed. That is, the first protective layer 210 may be disposed on a portion of the third surface 13 of the ceramic main body 10. The first opening 217 may overlap the first or second internal electrodes 150 and 160 exposed through the third surface 13 of the ceramic main body 10, and the first connection electrode 230 may be in contact with the first or second internal electrodes 150 and 160 through the first opening 217.

The first protective layer 210 may include a first lower continuous region 211, a first upper continuous region 213, and a first intermittent region 215.

The first lower continuous region 211 is a part in which the first protective layer 210 extends from the first surface 11 of the ceramic main body 10 through the inner side of the first corner portion 25 to a part of the third surface 13 of the ceramic main body 10. One end of the first lower continuous region 211 may be positioned on the first surface 11 of the ceramic main body 10, and the other end may be positioned on the third surface 13 of the ceramic main body 10. One end of the first lower continuous region 211 positioned on the third surface 13 of the ceramic main body 10 may be positioned on one side of the first opening 217, and this first opening 217 may be the first opening 217 positioned closest to the first surface 11 of the ceramic main body 10. The first lower continuous region 211 may extend continuously without a break from one end on the first surface 11 of the ceramic main body 10 to one end on the third surface 13 of the ceramic main body 10, and no openings may be formed.

The first upper continuous region 213 is a part in which the first protective layer 210 extends from the second surface 12 of the ceramic main body 10 through the inner side of the first corner portion 25 to a part of the third surface 13 of the ceramic main body 10. One end of the first upper continuous region 213 may be positioned on the second surface 12 of the ceramic main body 10, and the other end may be positioned on the third surface 13 of the ceramic main body 10. One end of the first upper continuous region 213 positioned on the third surface 13 of the ceramic main body 10 may be positioned on one side of the first opening 217, and this first opening 217 may be the first opening 217 positioned closest to the second surface 12 of the ceramic main body 10. The first upper continuous region 213 may extend continuously without a break from one end on the second surface 12 of the ceramic main body 10 to one end on the third surface 13 of the ceramic main body 10, and no openings may be formed.

The first intermittent region 215 is a region positioned between the first lower continuous region 211 and the first upper continuous region 213. That is, the first intermittent region 215 may be positioned between the first opening 217 positioned closest to the first surface 11 of the ceramic main body 10 and the first opening 217 positioned closest to the second surface 12 of the ceramic main body 10. The first opening 217 may be formed in the first intermittent region 215.

The first protective layer 210 may protrude further than the first connection electrode 230 in a direction toward the fourth surface 14 of the ceramic main body 10 on the first surface 11, the second surface 12, the fifth surface 15, and the sixth surface 16 of the ceramic main body 10. In addition, the first protective layer 210 may protrude further than the first plating electrode 250 in a direction toward the fourth surface 14 of the ceramic main body 10 on the first surface 11, the second surface 12, the fifth surface 15, and the sixth surface 16 of the ceramic main body 10.

The second protective layer 310 may include a portion extending from the fourth surface 14 onto the first surface 11 and the second surface 12 of the ceramic main body 10. Additionally, the second protective layer 310 may include a portion extending from the fourth surface 14 onto the fifth surface 15 and the sixth surface 16 of the ceramic main body 10. The second protective layer 310 may be at least partially covered by the second connection electrode 330. The second protective layer 310 may have a portion positioned between the ceramic main body 10 and the second connection electrode 330, and may be in contact with the ceramic main body 10. The second protective layer 310 may serve to bond the ceramic main body 10 and the second connection electrode 330.

The second protective layer 310 may have a second opening 317 formed on the fourth surface 14 of the ceramic main body 10. The second opening 317 is a portion where the second protective layer 310 is not partially disposed. That is, the second protective layer 310 may be disposed on a par of the fourth surface 14 of the ceramic main body 10. The second opening 317 may overlap the first or second internal electrodes 150 and 160 exposed through the fourth surface 14 of the ceramic main body 10, and the second connection electrode 330 may be in contact with the first or second internal electrodes 150 and 160 through the second opening 317.

The second protective layer 310 may include a second lower continuous region 311, a second upper continuous region 313, and a second intermittent region 315.

The second lower continuous region 311 is a part in which the second protective layer 310 extends from the first surface 11 of the ceramic main body 10 through the inner side of the second corner portion 35 to a part of the fourth surface 14 of the ceramic main body 10. One end of the second lower continuous region 311 may be positioned on the first surface 11 of the ceramic main body 10, and the other end may be positioned on the fourth surface 14 of the ceramic main body 10. One end of the second lower continuous region 311 positioned on the fourth surface 14 of the ceramic main body 10 may be positioned on one side of the second opening 317, and this second opening 317 may be the second opening 317 positioned closest to the first surface 11 of the ceramic main body 10. The second lower continuous region 311 may extend continuously without a break from one end on the first surface 11 of the ceramic main body 10 to one end on the fourth surface 14 of the ceramic main body 10, and no openings may be formed.

The second upper continuous region 313 is a part in which the second protective layer 310 extends from the second surface 12 of the ceramic main body 10 through the inner side of the second corner portion 35 to a part of the fourth surface 14 of the ceramic main body 10. One end of the second upper continuous region 313 may be positioned on the second surface 12 of the ceramic main body 10, and the other end may be positioned on the fourth surface 14 of the ceramic main body 10. One end of the second upper continuous region 313 positioned on the fourth surface 14 of the ceramic main body 10 may be positioned on one side of the second opening 317, and this second opening 317 may be the second opening 317 positioned closest to the second surface 12 of the ceramic main body 10. The second upper continuous region 313 may extend continuously without a break from one end on the second surface 12 of the ceramic main body 10 to one end on the fourth surface 14 of the ceramic main body 10, and no openings may be formed.

The second intermittent region 315 is a region positioned between the second lower continuous region 311 and the second upper continuous region 313. That is, the second intermittent region 315 may be positioned between the second opening 317 positioned closest to the first surface 11 of the ceramic main body 10 and the second opening 317 positioned closest to the second surface 12 of the ceramic main body 10. The second opening 317 may be formed in the second intermittent region 315.

The second protective layer 310 may protrude further than the second connection electrode 330 in a direction toward the third surface 13 of the ceramic main body 10 on the first surface 11, the second surface 12, the fifth surface 15, and the sixth surface 16 of the ceramic main body 10. In addition, the second protective layer 310 may protrude further than the second plating electrode 350 in a direction toward the third surface 13 of the ceramic main body 10 on the first surface 11, the second surface 12, the fifth surface 15, and the sixth surface 16 of the ceramic main body 10.

For example, the average thickness of the protective layers 210 and 310 may be approximately 0.1 μm to 10 μm, but the present embodiment is not limited thereto.

The protective layers 210 and 310 may include a glass component composed of a mixture of oxides, and one or more selected from the group consisting of boron oxide, aluminum oxide, transition metal oxide, alkali metal oxide, and alkaline earth metal oxide, in combination with silicon oxide. For example, the protective layers 210 and 310 may include, but are not limited to, one or more components of barium oxide (BaO), calcium oxide (CaO), zinc oxide (ZnO), aluminum oxide (Al₂O₃), boron oxide (B₂O₃), sodium oxide (Na₂O), and copper (II) oxide (CuO) in combination with silicon dioxide (SiO₂). Additionally, the protective layers 210 and 310 may contain more than 5 mol % of sodium oxide (Na₂O) in combination with silicon oxide and more than 2 mol % of copper (II) oxide (CuO), but are not limited thereto. For example, the protective layers 210 and 310 may contain more than 7.5 mol % of sodium oxide (Na₂O) in combination with silicon oxide. As another example, the protective layers 210 and 310 may contain more than 10 mol % of sodium oxide (Na₂O) in combination with silicon oxide. In addition, for example, the protective layers 210 and 310 may contain more than 3 mol % of copper (II) oxide (CuO) in combination with silicon oxide. As another example, the protective layers 210 and 310 may contain more than 4 mol % of copper (II) oxide (CuO) in combination with silicon oxide. When sodium oxide (NaO) and/or copper (II) oxide (CuO) are included, the wettability of the protective layers 210 and 310 may be improved, thereby facilitating the formation of a continuous protective layers 210 and 310 between the ceramic main body 10 and the connection electrodes 230 and 330.

Compared to the first and second connection portions 21 and 31 and the first and second band portions 23 and 33, stress may be more concentrated in the first and second corner portions 25 and 35. Therefore, when cracks occur in the first and second corner portions 25 and 35, the damaged or cracked portions may become a path for moisture to penetrate. The protective layers 210 and 310 according to the embodiment increase the adherence between the ceramic main body 10 and the connection electrodes 230 and 330, thereby reducing the risk of dropping out of the external electrode that may easily occur at the first and second corner portions 25 and 35.

For example, the protective layers 210 and 310 may be formed by partially dipping a ceramic main body into a conductive paste including small glass particles, then coating it depending on the degree of dilution of the solution, heat drying it at a temperature below 200° C., and sintering the conductive paste.

The multilayer ceramic capacitor 1000 is classified based on its length and width. Therefore, even in multilayer ceramic capacitors with the same length or width, the size of the ceramic main body may vary depending on the thickness of the external electrode. That is, a multilayer ceramic capacitor with thinner external electrodes may have a larger ceramic main body compared to a multilayer ceramic capacitor with thicker external electrodes. A larger ceramic main body means that the above-mentioned active region is larger, which may further mean that the capacitance is larger. Ultimately, as the external electrode of the multilayer ceramic capacitor becomes thinner, the capacitance may increase. However, if the thickness of the external electrode becomes thin, moisture can easily penetrate into the ceramic main body, which may reduce the moisture resistant reliability of the multilayer ceramic capacitor. In the present embodiment, it is possible to prevent moisture from penetrating into the ceramic main body even when the external electrode is formed thin by forming a protective layer between the ceramic main body and the connection electrode.

The protective layers 210 and 310 may have low electrical conductivity. For example, the protective layers 210 and 310 may have electrical conductivity less than 10⁻⁷ S/cm. The electrical conductivity may be measured by a conductivity sensor. Other methods and/or tools appreciated by one of ordinary skill in the art, even if not described in the present disclosure, may also be used. The protective layers 210 and 310 configured as described above may prevent plating from spreading when forming the plating electrodes 250 and 350. That is, when the first and second protective layers 210 and 310 made of an insulating material protrude further than the first and second connection electrodes 230 and 330, the protective layers 210 and 310 may prevent the plating component from spreading over the protruding connecting electrodes 230 and 330 during the formation of the plating electrodes 250 and 350. Therefore, it is possible to prevent the plating electrodes 250 and 350 from being formed in unintended regions of the ceramic main body 10 beyond the protective layers 210 and 310.

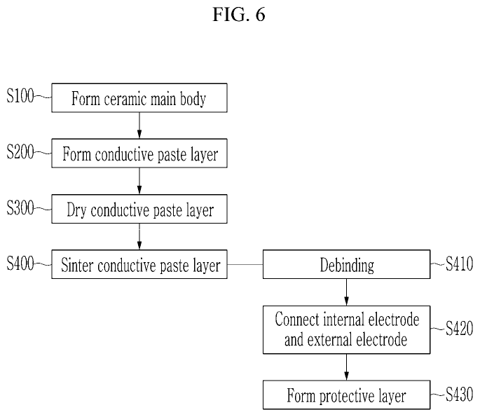

Hereinafter, a manufacturing method of a multilayer ceramic capacitor according to embodiments will be described with reference to FIG. 6.

FIG. 6 is a diagram illustrating a manufacturing method of a multilayer ceramic capacitor according to embodiments.

Referring to FIG. 6, in the method of manufacturing a multi-layer ceramic capacitor according to the embodiment, a ceramic main body is first formed (S100). To form the ceramic main body 10, a plurality of dielectric green sheets are first prepared. The dielectric green sheet may become the dielectric layer 140 of the ceramic main body 10 after sintering.

The dielectric green sheets may be manufactured by mixing ceramic powder, ceramic additives, organic solvents, plasticizers, binders, and dispersants to create a paste, and this paste may be manufactured into a sheet with a thickness of several micrometers through methods such as doctor blade or screen printing.

For example, the ceramic powder may include a dielectric ceramic including components such as BaTiO₃, CaTiO₃, SrTiO₃, or CaZrO₃. In addition, these components may further include auxiliary components such as Mn compounds, Fe compounds, Cr compounds, Co compounds, and Ni compounds. For example, (Ba₁₋ₓCaₓ) TiO₃, Ba(Ti_{1-y}Ca_{y})O₃, (Ba₁₋ₓCaₓ) (Ti_{1-y}Zr_{y})O₃, or Ba(Ti_{1-y}Zr_{y})O₃, in which Ca, Zr, etc. are partially used in BaTiO₃-based dielectric ceramic, may be included.

As a ceramic additive, for example, transition metal oxide or transition metal carbide, rare earth elements, magnesium (Mg), or aluminum (Al) may be used.

A conductive paste layer is formed on the surface of the dielectric green sheet. The conductive paste layer may become the first and second internal electrodes 150 and 160 after sintering.

The conductive paste layer may be formed by applying a conductive paste including a conductive metal to the surface of the dielectric green sheet using a method such as a doctor blade or screen printing method.

For example, a first conductive paste layer may be applied to the surface of a first dielectric green sheet in a first pattern, and a second conductive paste layer may be applied to the surface of a second dielectric green sheet in a second pattern. The first pattern and the second pattern may be aligned so that when the first and second dielectric green sheets are alternately stacked, some of the first and second conductive paste layers overlap and some do not overlap.

A dielectric green sheet laminate is manufactured by stacking the first and second dielectric green sheets. The first and second dielectric green sheets are stacked so that the first and second conductive paste layers overlap, but at least some do not overlap. Optionally, the dielectric green sheet laminate is compressed.

The dielectric green sheet laminate may be cut so that the first and second conductive paste layers are exposed through both end surfaces, respectively. The end of each of the first and second internal electrodes 150 and 160 may be exposed to one of both end surfaces of the dielectric green sheet laminate.

The ceramic main body 10 is manufactured by sintering the dielectric green sheet laminate at high temperature. After sintering, the dielectric green sheet forms the dielectric layer 140. The conductive paste layers formed on the surface of the dielectric green sheet form the first and second internal electrodes 150 and 160 by sintering, and may be alternately disposed with one dielectric layer 140 therebetween. The first and second internal electrodes 150 and 160 may be electrically insulated from each other by the dielectric layer 140.

A liquid conductive paste layer is formed on both cross-sections of the ceramic main body 10 where the first and second internal electrodes 150 and 160 are exposed (S200). The liquid conductive paste layer may be formed by dipping the ceramic main body 10 in a conductive paste including conductive metal and glass powder. As another example, the liquid conductive paste layer may be formed by printing the above-described conductive paste on the surface of the ceramic main body 10 using a screen printing method or gravure printing method, or by applying the above-described conductive paste to the surface of the ceramic main body 10.

Next, the liquid conductive paste layer is dried (S300). The liquid conductive paste layer may be dried at 200° C. or lower. After drying, the shape of the external electrode may be formed, and the external electrode may be temporarily fixed to the ceramic main body 10.

Next, by sintering the conductive paste layer (S400), a fixed external electrode may be formed and the internal electrode and the external electrode may be connected. Sintering the conductive paste layer may include debinding (S410), connecting the internal electrode and the external electrode (S420), and forming a protective layer (S430).

Debinding may be performed on the conductive paste layer (S410). Debinding includes removing organic materials such as binders in the conductive paste layer. Debinding may be performed at 600° C. or lower. Due to debinding, an empty space may be formed inside the conductive paste layer.

Next, the internal electrode and the external electrode may be connected (S420). In this step, adjacent metal powders may be necked and molten metal may form in an environment of 500° C. to 800° C. In this case, the molten metal may flow and fill the empty space formed by the above-described debinding. Additionally, molten metal may flow to the interface of the ceramic main body 10 to form a portion where the connection electrode of the external electrode and the internal electrode are connected.

Next, a protective layer may be formed (S430). In this step, adjacent glass powders may be necked and molten glass may form in an environment of 550° C. to 800° C. In this case, as the molten glass flows, it may fill the empty space inside the external electrode and form a glass film on the surface of the ceramic main body 10. The formed glass film may become the protective layers 210 and 310. The glass powders may be continuously connected to each other to cover the surface of the ceramic main body 10, and the first and second openings 217 and 317 may be formed in the portion where the connection electrode of the external electrode and the internal electrode are connected. The first and second openings 217 and 317 are portions where the glass film is not formed, and the internal electrodes 150 and 160 may be connected to the connection electrodes 230 and 330 through the first and second openings 217 and 317. The external electrode may become denser as molten metal and molten glass fill the empty space formed as a result of debinding.

Hereinafter, an Experimental Example comparing the Examples of the present disclosure and Comparative Examples is presented. However, the Examples and Experimental Examples described below are only intended to specifically illustrate or explain the present disclosure, and should not limit the scope of the present disclosure.

### Comparative Example, Examples and Determination Method

### Example

A plurality of sintered ceramic main bodies of 1005 size are prepared, and a liquid conductive paste layer including conductive metal and glass powder is formed on both ends of the laminate where the internal electrode is exposed. The conductive paste layer is dried and sintered to form an external electrode including a glass film and a connection electrode. Afterwards, a plating electrode is formed on the sintered external electrode.

### Comparative Example

A plurality of sintered ceramic main bodies of 1005 size are prepared, and a liquid conductive paste layer including conductive metal is formed on both ends of the laminate where the internal electrode is exposed. The conductive paste layer is dried and sintered to form an external electrode. Afterwards, a plating electrode is formed on the sintered external electrode.

### (Determination Method)

The formation of a glass film may be determined by the contrast difference in images taken of the multilayer ceramic capacitor with SEM, or by examining whether the components of the glass, such as Si, are detected using energy-dispersive X-ray spectroscopy (EDX) or an electron probe micro-analyzer (EPMA).

### Experimental Example: Performance of Multilayer Ceramic Capacitor

External electrode blister defects, plating spreading defects, and moisture resistant degradation of the multilayer ceramic capacitors manufactured in Examples and Comparative Examples are measured.

### 1) Measurement of External Electrode Blister

100 each of the multilayer ceramic capacitors of Examples and Comparative Examples are prepared. To check the effect of the multilayer ceramic capacitor of the embodiment, the external electrodes of the Comparative Examples and Examples are sintered under a strong reducing atmosphere. Then, a plating electrode is formed on the sintered external electrode.

TABLE 1
Result of external electrode blister measurement

| | Comparative | |
|---|---|---|
| | Example | Example |
| Number of samples | 100 | 100 |
| Number of samples | 15 | 0 |
| with external | | |
| electrode blister | | |

As shown in Table 1, in the Comparative Example, a defect in which the external electrode blister occurred in 15 samples out of 100 samples, while this defect did not occur in the sample of the Example. This is because the glass film acts as an adhesive between the ceramic main body and the connection electrode, fixing the connection electrode stronger.

### 2) Plating Spreading Defects

100 each of the multilayer ceramic capacitors of Examples and Comparative Examples are prepared. In the Example, the external electrode is formed so that the glass film protrudes toward the center of the ceramic main body than the connection electrode. Then, a plating electrode is formed on the sintered external electrode.

TABLE 2
Result of plating spreading measurement

| | Comparative | |
|---|---|---|
| | Example | Examples |
| Number of samples | 100 | 100 |
| Number of samples | 14 | 0 |
| with spread plating | | |

As shown in Table 2, in the Comparative Example, defects were observed where the plating spread to the surface of the ceramic main body, where the external electrode was not formed in 14 out of 100 samples.

In the Examples, such plating spreading defects did not occur. This is because the glass film prevents the plating electrode from diffusing past the glass film.

### 3) Measurement of Moisture Resistant Degradation

20 each of the multilayer ceramic capacitors of Examples and Comparative Examples are prepared. One channel is made up of 20 multilayer ceramic capacitors coupled in series.

For the Examples and Comparative Examples of a total of 20 channels prepared in this way, a voltage of 1.5Vr is applied to each channel for 12 hours under an environment of 85° C. and 85% RH.

TABLE 3
Result of moisture resistant degradation measurement

| | Comparative | |
|---|---|---|
| | Example | Example |
| Number of samples | 20 channels | 20 channels |
| Number of degradation occurrences | 3 channels | 0 channel |

As shown in Table 3, moisture resistant degradation occurred in 3 channels out of 20 channel samples, while moisture resistant degradation did not occur in the samples of the Example. This is because the glass film formed on the surface of the ceramic main body suppressed moisture penetration into the ceramic main body.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

What is claimed is:

1. A multilayer ceramic capacitor, comprising:
a ceramic main body including a first surface and a second surface facing each other in a first direction, a third surface and a fourth surface facing each other in a second direction and connecting the first surface and the second surface, and a fifth surface and a sixth surface facing each other in a third direction and connecting the first surface and the second surface;
an internal electrode disposed inside the ceramic main body;
a protective layer disposed on the third surface and the fourth surface of the ceramic main body; and
a connection electrode covering the protective layer,
wherein the protective layer includes a first protective layer disposed on the third surface and a second protective layer disposed on the fourth surface, and has one or more openings positioned on the third surface and the fourth surface.

2. The multilayer ceramic capacitor of claim 1, wherein:
the first protective layer and the second protective layer include portions extending to the first surface and the second surface, respectively.

3. The multilayer ceramic capacitor of claim 1, wherein:
the internal electrode is connected to the connection electrode through the one or more openings.

4. The multilayer ceramic capacitor of claim 1, wherein:
the protective layer comprises silicon (Si) oxide.

5. The multilayer ceramic capacitor of claim 1, wherein:
the protective layer has an electrical conductivity of less than 10⁻⁷ S/cm.

6. The multilayer ceramic capacitor of claim 4, wherein:
the protective layer further comprises sodium oxide (Na₂O).

7. The multilayer ceramic capacitor of claim 4, wherein:
the protective layer further comprises copper (II) oxide (CuO).

8. The multilayer ceramic capacitor of claim 4, wherein:
the connection electrode comprises particles of the same material as the protective layer.

9. The multilayer ceramic capacitor of claim 2, wherein:
the connection electrode comprises a first connection electrode that at least partially covers the first protective layer and a second connection electrode that at least partially covers the second protective layer,
the first protective layer has a portion that protrudes further than the first connection electrode in a direction toward the fourth surface on the first and second surfaces of the ceramic main body, and
the second protective layer has a portion that protrudes further than the second connection electrode in a direction toward the third surface on the first and second surfaces of the ceramic main body.

10. The multilayer ceramic capacitor of claim 9, further comprising:
a first plating electrode that at least partially covers the first connection electrode and a second plating electrode that at least partially covers the second connection electrode,
wherein the first protective layer has a portion that protrudes further than the first plating electrode in the direction toward the fourth surface on the first and second surfaces of the ceramic main body, and
the second protective layer has a portion that protrudes further than the second plating electrode in the direction toward the third surface on the first and second surfaces of the ceramic main body.

11. The multilayer ceramic capacitor of claim 1, wherein:
the first protective layer and the second protective layer have a portion in contact with the ceramic main body.

12. The multilayer ceramic capacitor of claim 2, wherein:
the portions of the first protective layer and the second protective layer extend continuously without an opening on the first surface and the second surface.

13. The multilayer ceramic capacitor of claim 10, wherein:
the protective layer includes glass including sodium (Na), copper (II) (Cu), and silicon (Si).

14. A multilayer ceramic capacitor, comprising:
a ceramic main body including a first surface and a second surface facing each other in a first direction, a third surface and a fourth surface facing each other in a second direction and connecting the first surface and the second surface, and a fifth surface and a sixth surface facing each other in a third direction and connecting the first surface and the second surface;
an internal electrode disposed inside the ceramic main body;
a protective layer disposed on a portion of the third surface and a portion of the fourth surface of the ceramic main body; and
a connection electrode covering the protective layer,
wherein the connection electrode includes a portion in contact with the internal electrode through a portion where the protective layer is not positioned on the third and fourth surfaces of the ceramic main body.

15. The multilayer ceramic capacitor of claim 14, wherein:
the protective layer comprises a portion extending onto the first surface and the second surface.

16. The multilayer ceramic capacitor of claim 15, wherein:
an opening is disposed in the portion where the protective layer is positioned on the third and fourth surfaces of the ceramic main body,
the protective layer has a portion continuously extending from an end of the protective layer on the first or second surface to another end of the protective layer positioned on one side of the opening.

17. The multilayer ceramic capacitor of claim 15, wherein:
the protective layer comprises a first protective layer extending along the first surface, the third surface and the second surface, and a second protective layer extending along the first surface, the fourth surface and the second surface,
the connection electrode comprises a first connection electrode covering the first protective layer and a second connection electrode covering the second protective layer,
the first protective layer has a portion that protrudes further than the first connection electrode in a direction toward the fourth surface on the first and second surfaces,
the second protective layer has a portion that protrudes further than the second connection electrode in a direction toward the third surface on the first and second surfaces.

18. The multilayer ceramic capacitor of claim 17, further comprising:
a first plating electrode covering the first connection electrode and a second plating electrode covering the second connection electrode,
wherein the first protective layer has a portion that protrudes further than the first plating electrode in a direction toward the fourth surface on the first and second surfaces,
the second protective layer has a portion that protrudes further than the second plating electrode in a direction toward the third surface on the first and second surfaces.

19. The multilayer ceramic capacitor of claim 15, wherein:
the portion of the protective layer extends continuously without an opening on the first surface and the second surface.

20. The multilayer ceramic capacitor of claim 18, wherein:
the protective layer includes glass including sodium (Na), copper (II) (Cu), and silicon (Si).
